(19) United States
(12) Patent Application Publication
(10) Pub. No.: US 2018/0146251 A1
(43) Pub. Date: May 24, 2018

(54) SEARCH FILTER PUSH

(71) Applicant: Cisco Technology, Inc., San Jose, CA (US)

(72) Inventors: Laurent GARDES, Meudon (FR); Yann Joel PRAT, Elancourt (FR); Olivier LACOUR, Paris (FR)

(21) Appl. No.: 15/359,634

(22) Filed: Nov. 23, 2016

(51) Int. Cl. H04N 21/45; H04L 29/08; H04N 21/258; H04N 21/475; H04N 21/41; H04N 21/4363; H04N 21/6336; H04N 21/482

(52) U.S. Cl. CPC H04N 21/4532; H04L 67/26; H04N 21/25891; H04N 21/4756; H04N 21/4828; H04N 21/43637; H04N 21/6336; H04N 21/4825; H04N 21/4126

(57) ABSTRACT

In one embodiment, a receiver-decoder device includes a receiver to receive encoded video content, a decoder to decode the encoded video content, a processor to send a push proposition to a mobile device running, television remote control software via a wireless link, the posh proposition indicating an electronic program guide search filter which is activated by the receiver-decoder device on receiving a confirmation from the mobile device, receive a confirmation from the mobile device, via the wireless link, the confirmation indicating that a selectable item based on the push proposition was selected on the mobile device, filter a list of program items with the search filter yielding a filtered program item list, and display an electronic program guide including items from the filtered program item list. Related apparatus and methods are also described.

### TECHNICAL FIELD

The present disclosure generally relates to pushing a search filter proposition to a remote device.

### BACKGROUND

An electronic program guide (EPG) is an application used with digital set-top boxes and newer television sets to list current and scheduled programs that are and/or will be available on each channel and a short summary or commentary for each program.

In consumer electronics, a remote control is a component of an electronic device such as a television set, DVD player, or other home appliance, used to operate the device wirelessly and/or remotely. Commonly, remote controls are consumer infrared (IR) devices which send digitally-coded poises of IR radiation to control functions such as power, volume, tuning, temperature set point, fan speed, or other features. Remote controls for these devices are usually small wireless handheld objects with an array of buttons for adjusting various settings such as television channel, track number, and volume. For many devices, the remote control contains all the function controls while die controlled device itself has only a handful of essential primary controls. Earlier remote controls in 1973 used ultrasonic tones. The remote control code, and thus the required remote control device, is usually specific to a product line, but there are universal remotes, which emulate the remote control made for most major brand devices. Remote control has continually evolved and advanced over recent years to include Bluetooth connectivity, motion sensor-enabled capabilities and voice control. Tablet devices and mobile telephones (such as smart phones) may provide remote control functionality through a suitable downloadable application.

### BRIEF DESCRIPTION OF THE DRAWINGS

The present disclosure will be understood and appreciated more fully from the following detailed description, taken in conjunction with the drawings in which:

FIG. 1 is a partly pictorial, partly block diagram view of a posh search-proposition system including a mobile device and a receiver-decoder device constructed and operative in accordance with an embodiment of the present disclosure;

FIGS. 2A-2C are views of the mobile device of FIG. 1 displaying a user interface;

FIG. 3 is a partly pictorial partly block diagram view of the push search-proposition system showing a continuation being sent from the mobile device to the receiver-decoder device of FIG. 1;

FIG. 4 is a pictorial view of the mobile device of FIG. 1 and a display of a user interface screen including a filtered list;

FIG. 5 is a block diagram view of the receiver-decoder device of FIG. 1;

FIG. 6 is a flow chart of an exemplary method of operation of the receiver-decoder device of FIG. 5;

FIG. 7 is a block diagram view of the mobile device of FIG. 1; and

FIG. 8 is a flow chart of an exemplary method of operation of the mobile device of FIG. 7.

### DESCRIPTION OF EXAMPLE EMBODIMENTS

### Overview

There is provided in accordance with an embodiment of the present disclosure, a receiver-decoder device including a receiver to receive encoded video content, a decoder to decode the encoded video content, a processor to send a push proposition to a mobile device running television remote control software via a wireless link, the push proposition indicating an electronic program guide search filter which is activated by the receiver-decoder device on receiving a confirmation from the mobile device, receive a confirmation from the mobile device, via the wireless link, the confirmation indicating that a selectable item based on the push proposition was selected on the mobile device, filter a list of program items with the search filter yielding a filtered program item list, and display an electronic program guide including items from the filtered program item list.

There is also provided in accordance with another embodiment of the present disclosure, a mobile device including a processor, and a memory to store data used by the processor, wherein the processor is operative to receive a push proposition from a receiver-decoder device via a wireless link, the push proposition indicating a search filter which is activated by the receiver-decoder device on receiving confirmation from the mobile device to filter a list of program items yielding a filtered program list and display an electronic program guide including items from the filtered program item list, display a television remote control user interface including a selectable item which is based on the push proposition, receive a user selection of the selectable item, and send a confirmation to the receiver-decoder device, via the wireless link, the confirmation indicating that the selectable item was selected.

There is also provided in accordance with still another embodiment of the present disclosure, a first device including a processor, and a memory to store data used by the processor, wherein the processor is operative to send a push proposition to a second device via a wireless link, the push proposition indicating a search filter which is activated by the first device on receiving a confirmation from the second device, receive a confirmation from the second device, via the wireless link, the confirmation indicating that a selectable item based on the push proposition was selected on the second device, filter a list of items with the search filter yielding a filtered list, and display a user interface screen including items from the filtered list.

There is also provided in accordance with yet another embodiment of the present disclosure, a first device including a processor, and a memory to store data used by the processor, wherein the processor is operative to receive a push proposition from a second device via a wireless link, the push proposition indicating a search filter which is activated by the second device on receiving confirmation from the first device, display a user interface including a selectable item which is based on the push proposition, receive a user selection of the selectable item, and send a confirmation to the second device, via the wireless link, the confirmation indicating that the selectable item was selected.

### Detailed Description

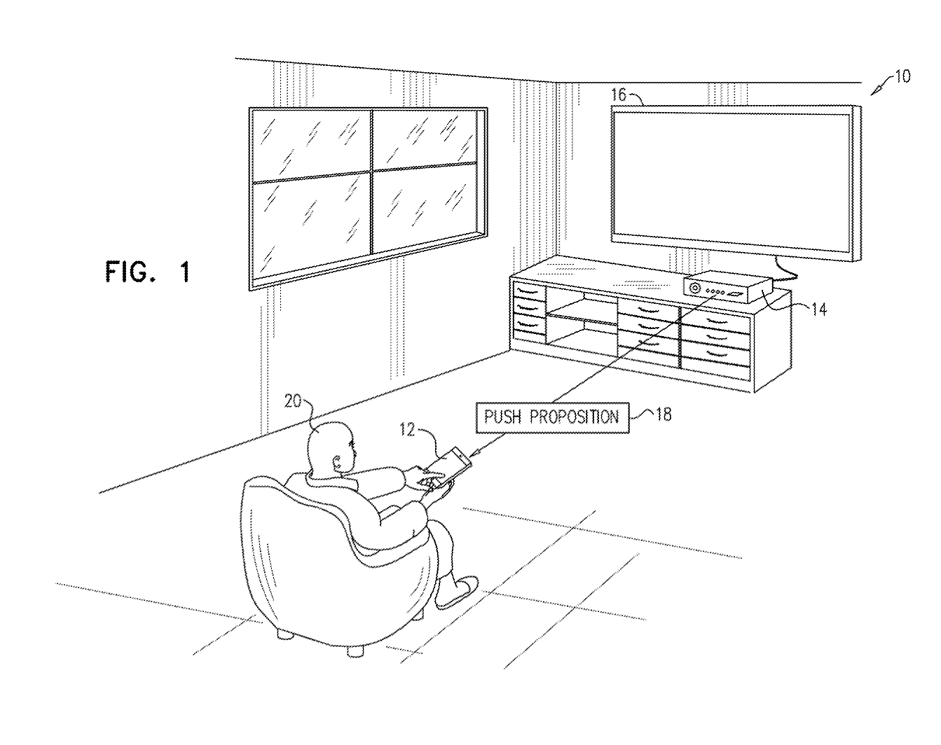

Reference is now made to FIG. 1, which is a partly pictorial, partly block diagram view of a push search-proposition system 10 including a mobile device 12 and a receiver-decoder device 14 constructed and operative in accordance with an embodiment of the present disclosure. The receiver-decoder device 14 is operative to receive and decode encoded video and audio content. The encoded video content may be received via any suitable communication method, for example, but not limited to, cable, satellite, Internet Protocol, wireless or terrestrial, from a broadcast Headend and/or content server, by way of example only. The receiver-decoder device 14 may be a set-top box or any other processing device (for example, but not limited to, a personal computer, a laptop computer or television device including a receiver-decoder and s display screen) configured for receiving, decoding and rendering video and audio content. The receiver-decoder device 14 is also operative to render the decoded video content on a display device 16. The receiver-decoder device 14 may be operative to run interactive television (TV) applications, for example, but not limited to, an electronic program guide and/or sports applications and/or shopping applications.

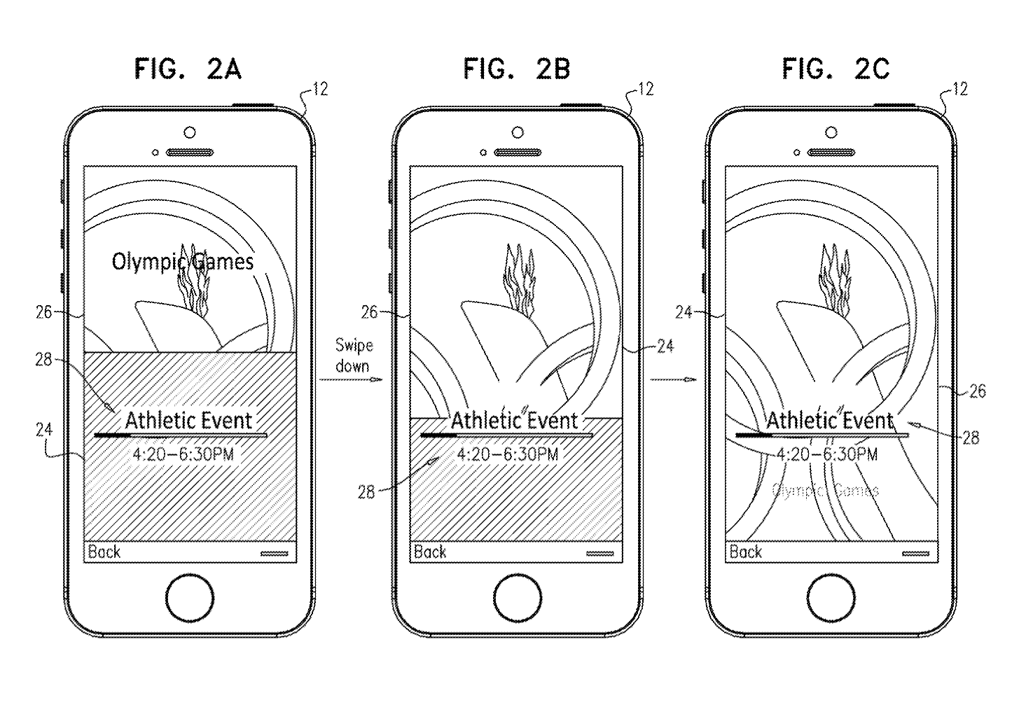

The receiver-decoder device 14 is operative to prepare a push proposition 18 and seed the push proposition 18 to the mobile device 12 via a wireless link, for example, but not limited to, via a Bluetooth link between the mobile device 12 and the receiver-decoder device 14 or via a wireless home router which is operationally (wired and/or wirelessly) connected to the mobile device 12 and the receiver-decoder device 14. The push proposition 18 indicates a search filter, for example, an electronic program guide search filter or shopping search filter. The search filter is activated by the receiver-decoder device 14 on receiving a confirmation from the mobile device 12 to filter a list of items (for example, but not limited to, program items or purchasable items) yielding a filtered list (e.g., filtered program list) and display an electronic program guide or user interface screen including items from the filtered list of items as will be described in more detail with reference to FIGS. 2A-4. In other words, the push proposition 18 is used to suggest a possible search filter to a user 20 of the mobile device 12 and on acceptance of the search filter suggestion by the user 20, the receiver-decoder device 14 may perform filtering and display filtered results on the display device 16. It should be noted that the display device 16 may be integrated with the receiver-decoder device 14 or may be a separate device from the receiver-decoder device 14. It should also be noted that the display device 16 is generally a separate device from, and is not integrated with, the mobile device 12. The mobile device 12 is operative to receive the push proposition 18 from the receiver-decoder device 14 via the wireless link.

It will be appreciated that the search filter associated with the push proposition 18 may be generated in a Headend or other content server and then pushed to the receiver-decoder device 14. Additionally, or alternatively, the push proposition 18 may be generated in the receiver-decoder device 14. Generation of the push proposition 18 may be based on available filter categories, e.g., genres, actors, titles, and/or shopping categories and/or based on known user preferences.

Reference is now made to FIGS. 2A-2C, which are views of the mobile device 12 of FIG. 1 displaying a user interface 24, for example, but not limited to, a television remote control user interface or any suitable user interface, including a selectable item 26 which is based on the push proposition 18 of FIG. 1. The top half of the user interface 24 of FIG. 2A shows the selectable item 26 and the bottom half of the user interface 24 of FIG. 2A provides details of a TV program 28 currently being viewed. In the example of FIG. 2A the selectable item 26 includes the descriptive text “Olympic Games” which is indicative of the search filter associated with the push proposition 18 (FIG. 1) received by the mobile device 12 from the receiver-decoder device 14 (FIG. 1). It will be appreciated that the user interlace 24 may include any suitable functionality e.g.,. remote control functionality, buttons and features. It will be appreciated that the selectable item 26 may take any suitable form and be arranged on the user interface 24 in any suitable manner, e.g., at the bottom, and/or at the side of the user interface 24.

The selectable item 26 may be selected using any suitable selection method, for example, but not limited to, swiping in one or more directions, clicking or double clicking. FIGS. 2A-2C show that the selectable item 26 is selected by the user 20 (FIG. 1) swiping the selectable item 26 in a downward direction until the picture on the top half of the user interface 24 in FIG. 2 A fills the whole screen in FIG. 2C. In such a manner the mobile device 12 receives a user selection of the selectable item 26.

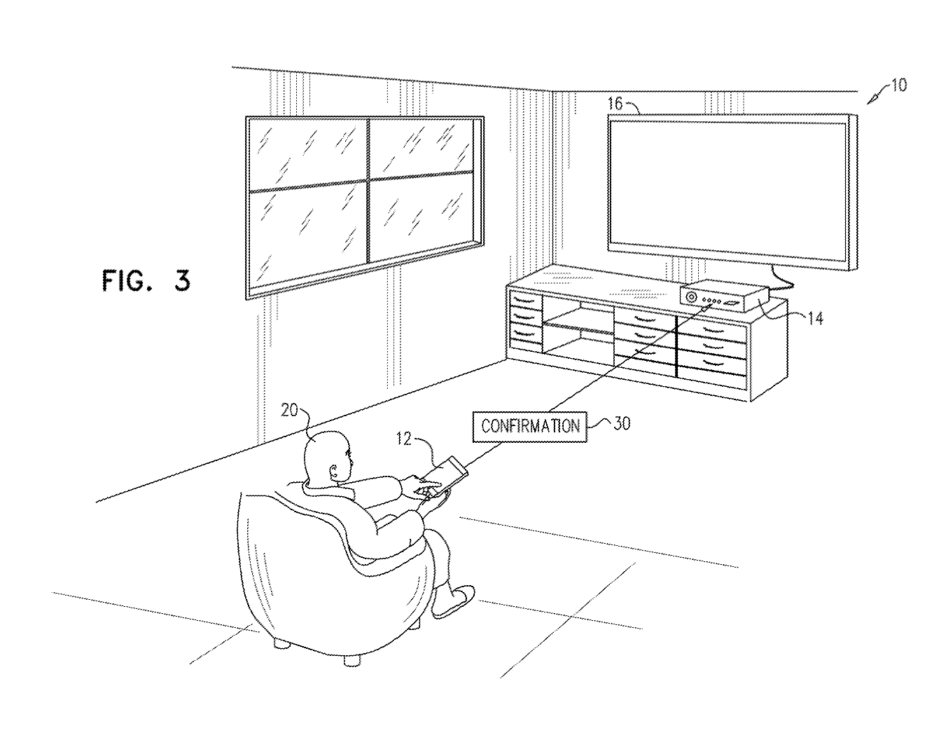

Reference is now made to FIG. 3, which is a partly pictorial, partly block diagram view of the push search-proposition system 10 showing a confirmation 30 being sent from the mobile device 12 to the receiver-decoder 14 device of FIG. 1. In response to receiving the user selection of the selectable item 26 (FIG. 2A), the mobile device 12 is operative to send the confirmation 30 to the receiver-decoder device 14, via the wireless link between the receiver-decoder device 14 and the mobile device 12. The confirmation indicates that the selectable item 26 of FIG. 2A) was selected. The receiver-decoder device 14 is operative to receive the confirmation 30 from the mobile device 12, via the wireless link.

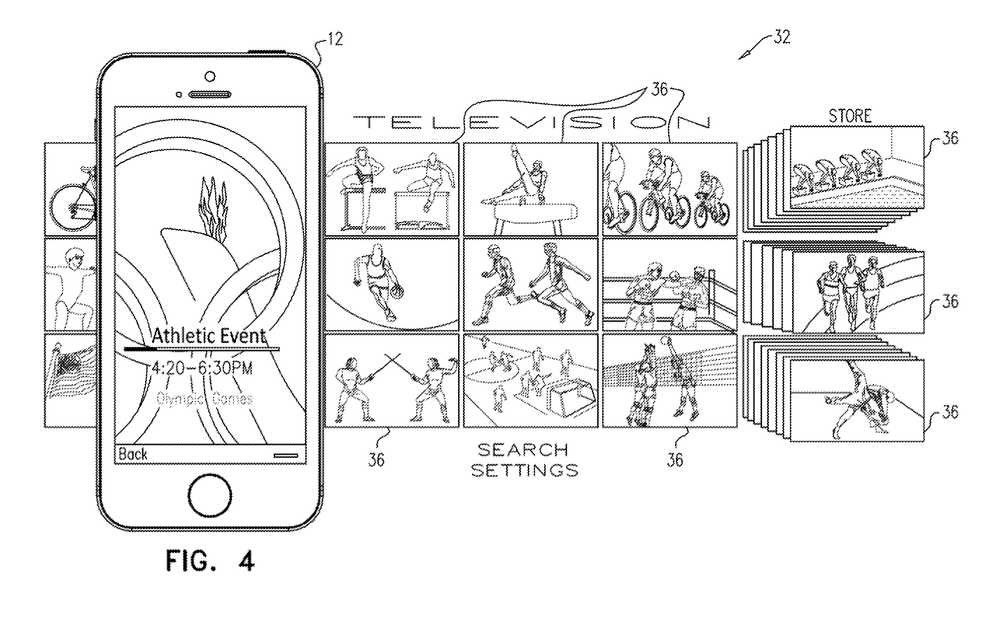

Reference is now made to FIG. 4, which is a pictorial view of the mobile device 12 of FIG. 1 and a display of a user interface screen 32 including items 36 (only some labeled for the sake of simplicity) from a filtered list. In response to receiving the confirmation 30 (FIG. 3) from the mobile device 12, the receiver-decoder device 14 is operative to filter a list of items (for example, a list of program items or purchasable items) with the search filter associated with the push proposition 18 (FIG. 1) yielding a filtered list (e.g., a filtered program item list or filtered purchasable item list). The receiver-decoder device 14 (FIG. 1) is operative to prepare and display the user interface screen 32, e.g., an electronic program guide or shopping application, including items 36 from the filtered list. In the example of FIG. 4, the items 36 are program items that are associated with the Olympic Games, as per the exemplary indication for the selectable stem 26 in FIG. 2A. It should be noted that some of the items 36 are program items of live television and some are video-on-demand (VOD) items.

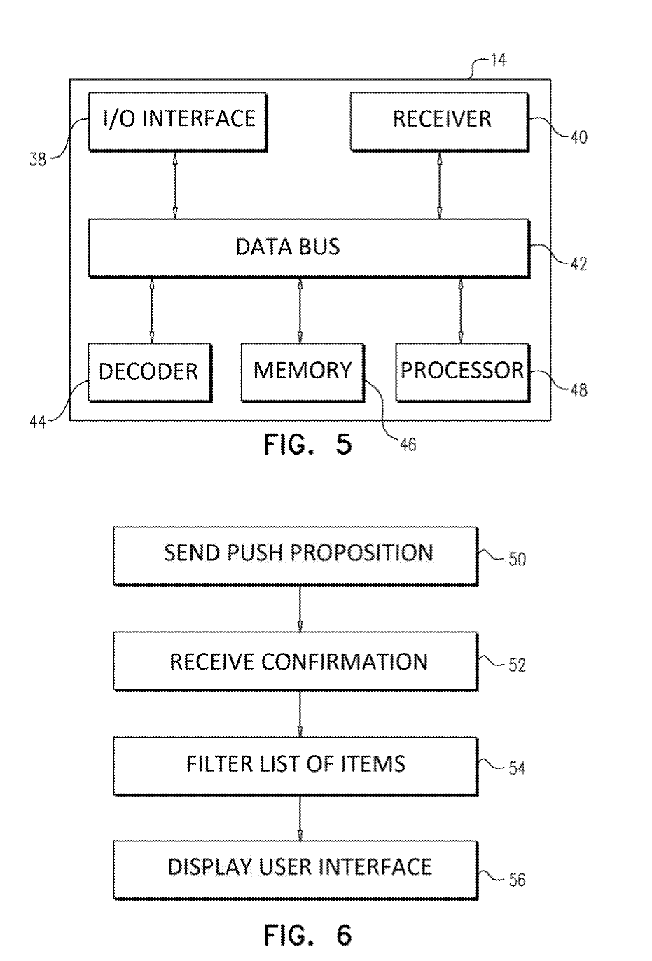

Reference is now made to FIG. 5, which is a block diagram view of the receiver-decoder device 14 of FIG. 1. The receiver-decoder device 14 includes an input/output (I/O) interface 38, a receiver 40, a data bus 42, a decoder 44, a memory 46 and a processor 48. The I/O interface 38 is operative to send and receive data wirelessly, to and from, the mobile device 12, respectively. The receiver 40 is operative to receive encoded video content. The decoder 44 is operative to decode and render the encoded video content. The memory 46 is operative to store data used by the processor 48. The data bus 42 is operative to connect the various elements of the receiver-decoder device 14 together for data transfer purposes. The processor 48 is described in more detail below with reference to FIG. 6.

Reference is now made to FIG. 6, which is a flow chart of an exemplary method of operation of the receiver-decoder device 14 of FIG. 5. The processor 48 (FIG. 5) is operative to send the push proposition 18 (FIG. 1) to the mobile device 12 (FIG. 1) (or any other device which is external to the receiver-decoder device 14 running a user interface software application, e.g., a television remote control software application or remote control software) via a wireless link (e.g., via Bluetooth and wireless home router) operationally connected to the I/O interface 38 (block 50). The push proposition 18 indicates a search filter, e.g., an electronic program guide search filter, which is activated by the receiver-decoder device 14 on receiving the confirmation 30 (FIG. 3) from the mobile device 12. The processor 48 is operative to receive the confirmation 30 from the mobile device 12, via the wireless link (block 52). The confirmation 30 indicates that the selectable item 26 (FIGS. 2A-C) based on the push proposition 18 was selected on the mobile device 12. In response to receiving the confirmation 30 from the mobile device 12, the processor 48 is operative to filter a list of items, e.g., a list of program items or purchasable items, with the search filter yielding a filtered list, e.g., a filtered program item list or filtered purchasable item list (block 54). The processor 48 is operative to display a user interface screen, e.g., an electronic program guide or shopping application, including items from the filtered list (block 56) on a display device operationally connected to the receiver-decoder device 14 such as a television screen or display monitor or projector and screen device. The processor 48 is typically not operative to display the user interface screen on a display device or screen integrated with the mobile device 12. The user interface prepared by the processor 48 of the receiver-decoder device 14 is typically not displayed on the same display device as the user interface prepared by the mobile device 12 described in more detail below with reference to FIG. 8. Items may then be selected from the user interface screen for rendering and/or purchase.

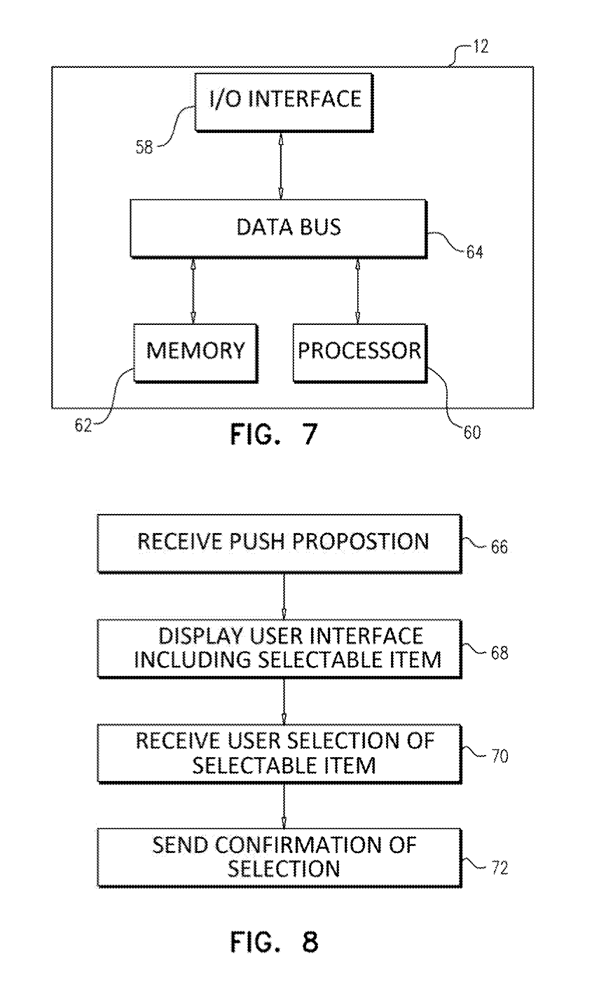

Reference is now made to FIG. 7, which is a block diagram view of the mobile device 12 of FIG. 1. The mobile device 12 includes an input/output (I/O) interface 58, a processor 60, a memory 62 and a data bus 64. The I/O interface 58 is operative to send and receive data wirelessly, to and from, the receiver-decoder device 14, respectively. The memory 62 is operative to store data used by the processor 60. The data bus 42 is operative to connect the various elements of the mobile device 12 together for data transfer purposes. The processor 60 is described in more detail below with reference to FIG. 8.

Reference is now made to FIG. 8, which is a flow chart of an exemplary method of operation of the mobile device 12 of FIG. 7. The processor 60 is operative to receive the push proposition 18 (FIG. 1) from the receiver-decoder device 14 via the wireless link operationally connected to the I/O interface 58 (block 66). The processor 60 is operative to display a television remote control user interface or other user interface including the selectable item 26 (FIG. 2A) which is based on the push proposition 18 (block 68). The processor 60 is operative to receive a user selection of the selectable item (block 70). The processor 60 is operative to send the confirmation 30 (FIG. 3) to the receiver-decoder device, via the wireless link (block 72). The continuation 30 indicates that the selectable item 26 was selected.

It will be appreciated that the mobile device 12 may be any suitable device, for example, but not limited to, a smart phone with a suitable user interface software installed or a tablet device or a specially designed remote control device. It will be appreciated that in the system 10, the receiver-decoder device 14 may be replaced by any suitable processing devices. For example, in the system 10, receiver-decoder de vice 14 may be replaced by a laptop or desktop computer which sends the push proposition 18 to the mobile device 12 or other suitable device and on receiving the confirmation 30, the laptop or desktop computer performs a filtering of a list and displays items from the filtered list in a user interface.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It will be appreciated that various features of the disclosure which are, for clarity, described in the contexts of separate embodiments may also be provided in combination in a single embodiment. Conversely, various features of the disclosure which are, for brevity, described in the contest of a single embodiment may also be provided separately or in any suitable sub-combination.

It will be appreciated by persons skilled in the art that the present disclosure is not limited by what has been particularly shown and described hereinabove. Rather the scope of the disclosure is defined by the appended claims and equivalents thereof.

1. A receiver-decoder device comprising:
a receiver to receive encoded video content;
a decoder to decode the encoded video content;
a processor to:
prior to displaying an electronic program guide screen on a display device, which is not integrated with a mobile device, send a push proposition, via a wireless link, to the mobile device running television remote control software, the push proposition indicating an electronic program guide search filter;
receive a confirmation from the mobile device, via the wireless link, the confirmation indicating that a selectable item based on the push proposition was selected on the mobile device;
filter a list of program items with the search filter yielding a filtered program item list; and
display, on the display device, the electronic program guide screen including items from the filtered program item list but not including a selectable item for selecting the search filter, and wherein the filtered program item list is not sent to the mobile device for display on the mobile device.

2. A mobile device comprising a processor; and a memory to store data used by the processor, wherein the processor is operative to:
receive a push proposition from a receiver-decoder device via a wireless link, the push proposition indicating an electronic program guide search filter;
display a television remote control user interface screen including a selectable item which is based on the push proposition, wherein the television remote control user interface screen does not include a program item list;
receive a user selection of the selectable item; and
send a confirmation to the receiver-decoder device, via the wireless link, the confirmation indicating that the selectable item was selected.

3. A first device comprising a processor; and a memory to store data used by the processor, wherein the processor is operative to:
prior to displaying a user interface screen on a display device, which is not integrated with a second device, send a push proposition to the second device via a wireless link, the push proposition indicating a search filter;
receive a confirmation from the second device, via the wireless link, the confirmation indicating that a selectable item based on the push proposition was selected on the second device;
filter a list of items with the search filter yielding a filtered list; and
display, on the display device, the user interface screen including items from the filtered list but not including a selectable item for selecting the search filter, and wherein the filtered list is not sent to the second device for display on the second device.

4. The device according to claim 3, wherein the processor is operative to filter the list of items in response to receiving the confirmation from the second device.

5. (canceled)

6. The device according to claim 3, wherein the second device is a mobile device.

7. The device according to claim 3, wherein the second device is operative to ran television remote control software.

8. The device according to claim 7, wherein the user interface screen is an electronic program guide and the filtered list includes a filtered program item list.

9. A first device comprising a processor; and a memory to store data used by the processor, wherein the processor is operative to:
receive a push proposition from a second device via a wireless link, the push proposition indicating a search filter;
display a user interface screen including a selectable item which is based on the push proposition, wherein the user interface screen does not include a filtered list which is filtered based on the search filter;
receive a user selection of the selectable item; and
send a confirmation to the second device, via the wireless link, the confirmation indicating that the selectable item was selected.

10. The device according to claim 9, wherein the user interface includes a television remote control user interface.

11. The device according to claim 9, wherein the search filter includes a filter for filtering a list of program items by the second device.

12. The device according to claim 9, wherein the second device is a receiver-decoder device.

13. A method comprising:
prior to displaying a user interface screen on a display device, which is not integrated with a first device, sending a push proposition to the first device via a wireless link, the push proposition indicating a search filter;
receiving a confirmation from the first device, via the wireless link, the confirmation indicating that a selectable item based on the push proposition was selected on the device;
filtering a list of items with the search filter yielding a filtered list; and
displaying, on the display device, the user interface screen including items from the filtered list but not including a selectable item for Selecting the search filter, and wherein the filtered list is not sent to the first device for display on the first device.

14. (canceled)

15. The method according to claim 13, wherein the filtering is performed in response to the receiving the confirmation from the first device.

16. The method according to claim 13, wherein the first device is a mobile device.

17. The method according to claim 13, wherein: the first device is operative to run television remote control software; the user interface screen is an electronic program guide; and the filtered list includes a filtered program item list.

18. A method comprising:
receiving a push proposition from a device via a wireless link, the push proposition indicating a search filter which is activated by a device;
displaying a user interface screen including a selectable item which is based on the push proposition, wherein the user interface screen does not include a filtered list which is filtered based on the search filter;
receiving a user selection of the selectable item; and
sending a confirmation to the device, via the wireless link, the confirmation indicating that the selectable item was selected.

19. The method according to claim 18, wherein: the uses interface includes a television remote control user interface; and the search filter includes a filter for filtering a list of program items by the device.

20. The method according to claim 18, wherein the device is a receiver-decoder device.
